(19) United States
(12) Patent Application Publication
(10) Pub. No.: US 2014/0129184 A1
(43) Pub. Date: May 8, 2014

(54) Systems, Methods, and Media for Labeling Three Dimensional Surfaces

(71) Applicant: Avery Dennison Corporation, Pasadena, CA (US)

(72) Inventors: Ali R. MEHRABI, Glendale, CA (US); Juan M. DE SANTOS AVILA, Temple City, CA (US); Reza MEHRABI, Tujunga, CA (US)

(73) Assignee: Avery Dennison Corporation, Pasadena, CA (US)

(21) Appl. No.: 14/074,814

(22) Filed: Nov. 8, 2013

Related U.S. Application Data
(60) Provisional application No. 61/723,901, filed on Nov. 8, 2012.

(51) Int. Cl. G06F 17/50; G06T 17/00

(52) U.S. Cl. CPC G06F 17/50; G06T 17/00
USPC 703/1

(57) ABSTRACT

A strategy for predicting the occurrence of labeling defects is described. Also described are associated systems and computer-readable media for predicting such defects.

### CROSS-REFERENCE TO RELATED APPLICATION

This application claims priority from U.S. Provisional Application No. 61/723,901 filed on Nov. 8, 2012, which is incorporated herein by reference in its entirety.

### FIELD

The present subject matter relates to systems, methods, and media for labeling three dimensional surfaces and for predicting potential for labeling defects.

### BACKGROUND

Labels and other thin polymeric films are routinely applied to a wide array of surfaces to provide information or decoration. For example, labels are applied to a variety of personal care products to provide ingredient information, instructions for use, and supplier information regarding the particular product to which the label is attached. Another function of labels is to draw attention to a labeled product, for example by the use of visually engaging color schemes or patterns, and aesthetically attractive designs. Thus, appearance of the label and its coloring, designs, and/or indicia is important.

Labels are typically attached to containers or other surfaces of interest by a thin layer of adhesive. The application process may involve heating of the label and/or the container, such as for example to activate the adhesive. Heating may also be performed to promote intimate contact between the label and the surface of interest such as for example to reduce the potential for wrinkles and “darts” or other defects in the label upon adherence.

Depending upon the material(s) constituting the label, the label may undergo a dimensional change upon heating. For example, many labels are formed from heat shrink film materials. Such films or “shrink films” are designed to shrink in one direction (and so are referred to as unidirectional or monodirectional) or in two directions (and so are referred to as bidirectional) upon heating to a temperature equal to or greater than their heat shrink temperature. Therefore, it will be appreciated that if designs and/or indicia are applied to a label and if the label undergoes shrinkage during application of the label to a container or other surface, the previously applied designs and/or indicia will be distorted.

Another difficulty encountered in the labeling arts is labeling a three dimensional surface, and particularly such a surface having relatively sharply curved regions such as rounded corners or edges of containers. Recently, a growing trend in product labeling is the use of larger labels on containers in order to cover a larger proportion of the surface area of the container. And so, the use of larger surface area labels on containers typically results in the label extending over at least a portion of sharply curved regions. Another consequence of this practice is that as label size increases, stresses and label deformation typically also increase, particularly for heat sensitive label materials, e.g. shrink films.

Labeling operations and particularly those associated with labeling popular, high volume consumer goods, typically involve sophisticated labeling and material handling systems. As will be appreciated, significant costs are associated with establishing and operating such systems. Furthermore, labels and their production may also involve extensive design efforts and significant costs. Accordingly, when considering applying a particular label to a certain container or surface configuration, it would be desirable to determine whether the proposed label and receiving surface are compatible, or if a relatively high likelihood of labeling defects will result.

Accordingly, a need exists for strategies which enable prediction of whether a particular label when applied to a designated surface such as a curved container surface, will exhibit labeling defects, and if so, whether the extent of defects will be unacceptable.

### SUMMARY

The difficulties and drawbacks associated with previous practices are addressed in the present subject matter.

In one aspect, the present subject matter provides a method for identifying a maximum label deformation resulting from applying a label to a three dimensional surface. The method comprises providing a representation of a three dimensional surface which is to receive a label. The method also comprises performing a mapping method upon the three dimensional surface which is to receive a label, utilizing the representation. The mapping method provides a two dimensional map of the three dimensional surface and identifies a maximum deformation of a label applied to the surface.

In another aspect, the present subject matter provides a method for identifying a maximum deformation of a label applied to a surface of interest, in which the labeled surface after label application will also exhibit an acceptable level of labeling defects. The method comprises providing a collection of physical models each having a surface of interest, the models having progressively increasing Gaussian curvature within the surface of interest. The method also comprises providing a plurality of labels. The method further comprises applying a label from the plurality of labels to each corresponding model and within the surface of interest to thereby produce a collection of labeled models. The method also comprises defining an acceptable level of labeling defects for the label and the surface of interest. The method additionally comprises inspecting the collection of labeled models whereby a single labeled model having the greatest Gaussian curvature yet which exhibits an acceptable level of labeling defects is identified. And, the method also comprises applying a mapping method to the surface of interest of at least the labeled model having the greatest Gaussian curvature yet which exhibits an acceptable level of labeling defects, to thereby identify the maximum deformation of the label applied to the surface of interest.

In yet another aspect, the present subject matter provides a system for identifying a maximum label deformation associated with applying a label to a three dimensional surface. The system comprises means for performing a mapping method upon a three dimensional surface which is to receive a label and identify a maximum deformation of the label.

In still another aspect, the present subject matter provides a system for identifying a maximum deformation of a label applied to a proposed curved surface of interest, which after label application will also exhibit an acceptable level of labeling defects. The system comprises means for performing a mapping method upon a representation of a reference surface of interest which exhibits the greatest Gaussian curvature yet which also exhibits an acceptable level of labeling defects upon application of a label thereto, wherein the means for performing the mapping method identifies the maximum deformation of the label applied to the reference surface of interest, MDp. The system also comprises means for performing a mapping method upon a representation of a proposed surface of interest and identifying the maximum deformation associated with the proposed surface, MDx. The system also comprises means for comparing the maximum deformation of the label applied to the reference surface of interest MDp with the maximum deformation associated with the proposed surface MDx.

In yet another aspect, the present subject matter also provides one or more computer-readable media having computer-usable instructions embodied thereon to perform a method for identifying a maximum label deformation resulting from applying a label to a three dimensional surface. The method comprises providing a representation of a three dimensional surface which is to receive a label. The method also comprises performing a mapping method upon the three dimensional surface which is to receive a label, utilizing the representation. The mapping method provides a two dimensional map of the three dimensional surface and identifies a maximum deformation of a label applied to the surface.

In still another aspect, the present subject matter provides one or more computer-readable media having computer-usable instructions embodied thereon to perform a method for identifying maximum deformation of a label applied to a surface of interest, in which the labeled surface after label application will also exhibit an acceptable level of labeling defects. The method comprises providing a collection of physical models each having a surface of interest, the models having progressively increasing Gaussian curvature within the surface of interest. The method also comprises providing a plurality of labels. The method additionally comprises applying a label from the plurality of labels to each corresponding model and within the surface of interest to thereby produce a collection of labeled models. The method also comprises defining an acceptable level of labeling defects for the label and the surface of interest. The method also comprises inspecting the collection of labeled models whereby a single labeled model having the greatest Gaussian curvature yet which exhibits an acceptable level of labeling defects is identified. And, the method also comprises applying a mapping method to the surface of interest of at least the labeled model having the greatest Gaussian curvature yet which exhibits an acceptable level of labeling defects, to thereby identify the maximum deformation of the label applied to the surface of interest.

As will be realized, the subject matter is capable of other and different embodiments and its several details are capable of modifications in various respects, all without departing from the subject matter. Accordingly, the drawings and description are to be regarded as illustrative and not restrictive.

### BRIEF DESCRIPTION OF THE DRAWINGS

FIG. 1 is a flow chart schematically illustrating a method in accordance with the present subject matter.

FIG. 2 is a flow chart schematically illustrating another method in accordance with the present subject matter.

FIG. 3 is a flow chart schematically illustrating another method in accordance with the present subject matter.

FIG. 4 is a schematic illustration of a system in accordance with the present subject matter.

FIG. 5 is a schematic illustration of another system in accordance with the present subject matter.

FIG. 6 is a front view of an object having a rounded front face, a rounded rear face, rounded edges, and rounded corners.

FIG. 7 is a side view of the object shown in FIG. 1.

FIG. 8 is a top view of the object shown in FIG. 1.

FIG. 9 is a perspective view of the object shown in FIG. 1.

FIGS. 10-14 are front views of progressively larger labels applied to the front face of the object shown in FIGS. 6-9, illustrating the extent of deformation in corresponding regions of the labels undergoing deformation.

### DETAILED DESCRIPTION OF THE EMBODIMENTS

The present subject matter provides methods, systems, and computer readable media for predicting the compatibility between a particular label and a particular surface. As will be appreciated, labels can undergo a wide range of deformations as a result of application to a receiving surface. Depending upon various factors such as the size, shape, thickness, and materials of the label, the label may deform such as by shrinking and/or stretching during and/or after application to the receiving surface. In addition, the shape, size, and/or contour of the receiving surface may also affect label deformation. The present subject matter provides strategies and related aspects for accurately predicting the type and/or extent of deformation and ultimately whether an applied label will be acceptable and exhibit no or low levels of defects; or whether an applied label will be unacceptable and exhibit relatively high levels of defects.

References are made herein to containers having developable surfaces or non-developable surfaces. A developable surface is a surface that can be flattened onto a planar surface without stretching, tearing, or any distortion. A developable surface has a zero Gaussian curvature. Examples of developable surfaces are cylinder, cone, and certain ruled surfaces (surfaces that are created by a line moving along a curved path.) A non-developable surface is a surface that cannot be flattened without any distortion onto a plane. A non-developable surface has a non-zero Gaussian curvature which can be positive or negative. Examples of a non-developable surface include, but are not limited to, the outer surface of a sphere (positive Gaussian curvature), a hyperbolic parabloid (negative Gaussian curvature), and a dome. It is to be understood that the present subject matter can be used for applying labels and films onto a wide variety of surfaces, including planar surfaces and developable surfaces. However, as explained in greater detail herein, the subject matter is particularly well suited for applying labels and films onto non-developable surfaces. Techniques for Assessing Deformation of Labels Applied to Non-developable Surfaces

Surface parameterization was introduced to computer graphics as a method for mapping textures onto surfaces. Parameterization attaches a geometric coordinate system to an object or a three dimensional surface. The choice of the coordinate system or representation of the surface depends upon a host of factors.

One approach when mapping a three dimensional surface is to use a conformal map. A conformal map is based upon a function that preserves angles. Conformal maps preserve both angles and the shapes of infinitesimally small figures or details, but not necessarily their size.

A particular type of conformal map is a least squares conformal map (LSCM). A least squares conformal map is a two dimensional representation of a three dimensional shape created using the Least Squares Conformal Mapping method. This mapping method is described in greater detail below.

In the present subject matter, two dimensional representations or maps of three dimensional surfaces are obtained by a Least Squares Conformal Mapping method described by Levy et al., “Least Squares Conformal Maps for Automatic Texture Atlas Generation,” SIGGRAPH 2002 Proceeding, 2002. Levy is concerned with mapping of a flat image (or texture) onto a discretized (triangulated) surface while maintaining minimal distortions of the image.

Specifically, the present subject matter predicts deformation or distortion of a label resulting from application of the label, and typically a heat shrink label, onto a surface, and typically a three dimensional surface. However, it will be appreciated that the present subject matter is not limited to label deformation resulting in a reduction in surface area, such as from label shrinkage. Instead, the subject matter also includes label deformation resulting in an increase in surface area, such as for example due to film stretching and/or film annealing. That is, depending upon the type, extent, and manner of forces applied to the label, and temperature of the application, both annealing and stretching can occur. Furthermore, it is also contemplated that label deformation could include a combination of both surface area reduction and surface area increase. For example, during and/or after label application, a label could undergo shrinkage in certain regions of the label and stretching in other regions of the label.

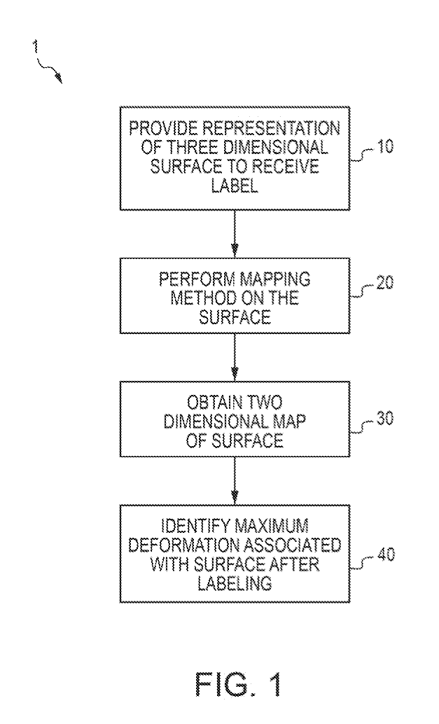

In accordance with the present subject matter, methods are provided for identifying a maximum label deformation associated with a three dimensional surface after labeling. The method generally comprises identifying or providing a three dimensional surface which is to receive a label. If an actual physical object or surface is not used, a mathematical or virtual representation of the object or surface can be used. This operation or operations is collectively shown as operation 10 in FIG. 1. FIG. 1 schematically depicts a method 1 for identifying a maximum label deformation associated with a three dimensional surface after labeling. The method also comprises performing a mapping method upon the three dimensional surface or representation thereof, which is to receive the label. This operation is shown as operation 20 in FIG. 1. Performing the mapping method provides a two dimensional map of the three dimensional surface and identifies a maximum deformation associated with the surface after labeling. Operation 30 in FIG. 1 depicts obtaining a two dimensional map of the surface of interest. And operation 40 illustrates identifying a maximum deformation associated with the surface of interest after labeling. The method 1 can be used in other methods according to the subject matter and described in greater detail herein.

In accordance with the present subject matter, methods for determining the potential for defects in applying a label to a surface of interest and particularly a non-developable surface are also provided. An example of a surface of interest which includes one or more non-developable surfaces is an exterior face of many containers for consumer healthcare products in a liquid form, e.g. shampoos and lotions. Typically, one or more labels are applied to the outer surface of such containers. Such outer surfaces typically include arcuate or curved regions and may include regions of non-developable surfaces. Specifically, in certain aspects, the present subject matter also provides methods for identifying the maximum Gaussian curvature of a surface, which after receiving a label, will also be free of an excessive amount of labeling defects.

The methods for determining the potential for labeling defects include a calibration phase and a prediction phase. The calibration phase provides or determines a reference or benchmark representation or model of a labeled container having a curved or arcuate surface with a label extending over at least a portion of the surface. The prediction phase provides an indication as to the potential for defects associated with labeling a surface of interest with a particular label. The prediction phase utilizes information determined or otherwise identified from the calibration phase. The calibration and prediction phases are described in greater detail herein as follows.

It will also be understood that the present subject matter includes the use of the prediction phase by itself or in conjunction with other calibration phases besides that described herein. And, the present subject matter includes the use of the prediction phase with other methods and/or analyses or determinations. Similarly, the present subject matter includes the use of the calibration phase by itself or in conjunction with other prediction phases besides that described herein. And, the subject matter includes the use of the calibration phase with other methods and/or analyses or determinations.

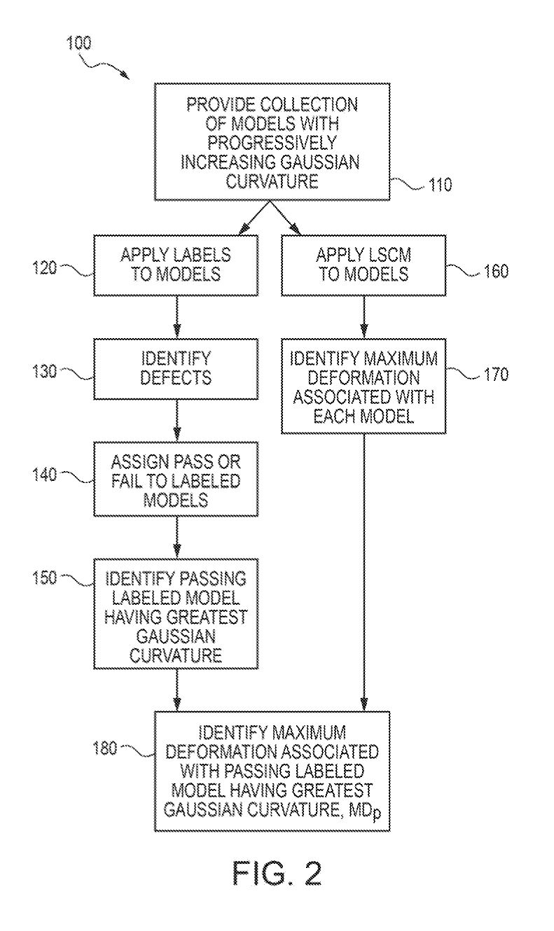

In accordance with the present subject matter, the calibration phase includes several operations as follows. FIG. 2 is a schematic flowchart illustrating a method 100 corresponding to the calibration phase. The method 100 comprises an operation of providing or identifying a collection of models corresponding to the surface of interest in which the models exhibit surfaces having progressively changing surface characteristics. For example, if the surface of interest has a particular Gaussian curvature and it is thought that such Gaussian curvature may lead to an unacceptable level of labeling defects, the models may exhibit a range of properties or characteristics such as a range of Gaussian curvatures. The Gaussian curvature of the surface of interest should be within the range of Gaussian curvatures represented by the models. This operation is depicted in FIG. 2 as operation 110. Typically the models are in the form of physical objects. In the event that the surface of interest is an outer surface of a container, the models could be in the form of a series of similar containers having similar sizes and shapes, but differing in the Gaussian curvature and specifically the extent of Gaussian curvature in one or more corresponding regions of the container. If the surface of interest is a face of such a container, the models could be in the form of similarly sized and shaped containers but differing in the extent of Gaussian curvature along their respective faces. The number of models with progressively changing Gaussian curvature, typically increasing or decreasing Gaussian curvature, is not critical. However, representative quantities can for example range from 2 to 100 or more, and typically from 3 to 10. Typically, the configuration of the region or surface of the models which is progressively varied is symmetrical. However, it will be understood that the present subject matter includes the use of nonsymmetrical.

The calibration method 100 also includes one or more operations of applying labels to the collection of models. Specifically, a collection of labels corresponding to the label which is to ultimately be applied to the surface of interest are provided. Typically, the labels are identical to one another or substantially so. And, the labels are formed from the same material(s) and prepared in the same fashion as the label which is to ultimately be applied to the surface of interest. The labels are applied to region(s) of the models corresponding to the surface of interest. This operation or collection of operations is collectively shown in FIG. 2 as 120. Application of the labels to the models can be performed manually or by use of one or more labeling machines or other equipment. Typically, application of the labels to the models is performed using the same processing equipment which will be used to apply label(s) to the surface of interest.

After labeling all or a portion of the models, the labeled models are inspected or otherwise evaluated. Defects in labeling and the labels are observed. This undertaking is collectively depicted as operation 130 in FIG. 2.

Next, an optional pass or fail designation or other rating is assigned to each of the labeled models. Assigning such designations may be reached entirely or partially upon the use of objective criteria such as the number of darts, wrinkles or other defects in labeling which are observed. Alternatively or in addition, subjective evaluation can be relied upon. These operation(s) are collectively shown in FIG. 2 as 140.

After identifying defect(s) or other undesirable aspects in operation 130 of the labeled models produced in operation 120, and after optionally designating models with pass/fail scores as depicted in operation 140, assessment of the labeled models is performed to identify the model having the greatest Gaussian curvature yet which does not include an excessive or undesirable amount of defects, i.e. which received a passing score. These operations are collectively shown in FIG. 2 as 150.

The calibration method 100 also comprises an operation 160 in which a mapping method and particularly a Least Squares Conformal Mapping (LSCM) method is performed. Specifically, an LSCM algorithm or procedure is applied to each of the models having progressively increasing Gaussian curvature. Such application can be conducted by providing a three dimensional mathematical representation or a virtual representation of each of the models of the collection. An example of such representation is a computer aided design (CAD) representation of the model, and specifically of the curved region or of the region corresponding to the surface of interest. A mapping method and particularly a Least Squares Conformal Mapping method is applied to the representation to provide a two dimensional map of the three dimensional surface of interest for each model.

As a result of applying a least squares conformal map to the various curved surfaces of the collection of models; the maximum deformation, i.e. stretching or shrinking, occurring along each of the curved surfaces is identified. This operation is designated in FIG. 2 as 170. It will be appreciated that mapping the surfaces of the models and/or identifying the maximum deformation associated with each model, i.e. operations 160 and 170, can be performed prior to or concurrently with one or more of operations 120, 130, 140, and 150.

The calibration method 100 also comprises an operation shown as 180 in FIG. 2 in which the maximum deformation associated with the passing model having the greatest Gaussian curvature is identified. That is, the model identified from operation 150 is used to identify the model having the maximum deformation yet which still receives a passing score (or is allowable or otherwise acceptable). The result of operation 180 is determination of the maximum Gaussian curvature for the surface of interest, e.g. a container, when applying the particular label of interest which leads to a low level or an otherwise acceptable level of labeling defects. The maximum deformation associated with a passing labeled model having the greatest Gaussian curvature in the region of interest is denoted herein as MDp.

The calibration method such as method 100 of FIG. 2, may include additional operations such as providing one or more determinations, identifications, or other information to other processes or methods.

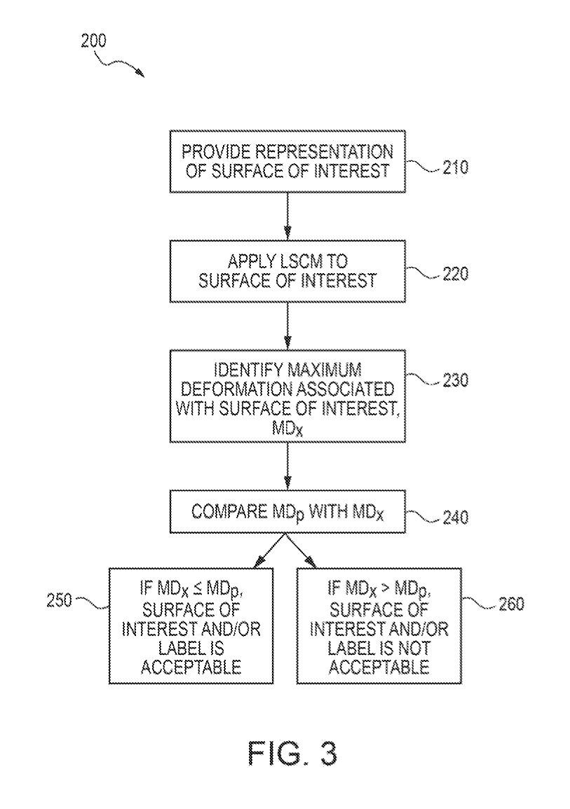

The present subject matter also provides a method or technique for predicting whether a designated label, when applied to a particular surface, will exhibit an acceptable level or extent of labeling defects or an unacceptable level or extent of labeling defects. In this prediction method, shown as method 200 in FIG. 3, a mathematical or virtual representation of a particular surface of interest is provided. An example of such a representation is a computer aided design (CAD) file. This is depicted as operation 210 in FIG. 3.

Next, mapping of region(s) or of the surface of interest is performed to determine the maximum extent of deformation associated with the region(s) or of the surface of interest. Typically, mapping is performed by Least Squares Conformal Mapping as previously described herein. These operations of mapping and identifying maximum deformation are shown in FIG. 3 as 220 and 230, respectively. As a result of operation 230, the maximum deformation associated with the surface of interest is determined and is referred to herein as MDx.

Next, the prediction method 200 comprises an operation in which the maximum deformation associated with a passing labeled model having the greatest Gaussian curvature, i.e. MDp, is compared to the maximum deformation associated with the surface of interest, i.e. MDx. This operation is shown in FIG. 3 as operation 240. In this comparison operation 240, it will be understood that the passing labeled model has a surface or region that is labeled which is similar to the surface of interest.

After operation 240, if the maximum deformation associated with the surface of interest MDx is equal to or less than the maximum deformation associated with the passing labeled model having the greatest Gaussian curvature MDp, then the surface of interest and/or the label is predicted to exhibit relatively low levels of labeling defects and so is acceptable. This condition is shown as 250 in FIG. 3. However, if the maximum deformation associated with the surface of interest MDx is greater than the maximum deformation associated with the passing labeled model having the greatest Gaussian curvature MDp, then the surface of interest and/or the label is predicted to exhibit a relatively high level of labeling defects and so is unacceptable. This condition is shown in FIG. 3 as 260.

Utilizing these strategies such as depicted via methods 1, 100, and/or 200; a database or library may be compiled of various MDp values associated with combinations of label material, labeling process conditions, instruments that apply label, and family of surfaces For example calibration should be done separately for surfaces with positive and negative Gaussian curvatures. If the label material (film, adhesive, thickness, etc.) or any process conditions or labeling instruments is changed, the calibration step must be repeated and new values for MDp must be determined. Then, upon consideration of a new label and/or container face contour, a user can readily assess or determine the MDx value for that combination of label and container face contour. Comparison of the MDp and MDx values as described herein provides a prediction as to whether the combination of label and container face contour under consideration will exhibit an acceptable level of labeling defects or an unacceptable level of labeling defects.

### Systems and Media

The present subject matter may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The subject matter may be practiced in a variety of system configurations, including hand-held devices, consumer electronics, general-purpose computers, specialty computing devices, etc. The subject matter may also be practiced in distributed computing environments where tasks are performed by remote-processing devices that are linked through a communications network. The disclosure describes specific software, i.e., specific program code segments, that are to be employed to configure a general purpose microprocessor to create specific logic circuits. These circuits are indicated to be the “means” corresponding to the claimed means limitations.

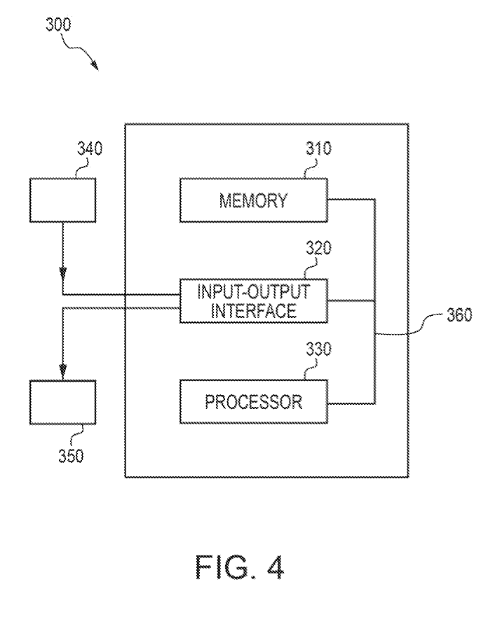

The present subject matter also provides systems for performing the previously described methods 1, 100 and/or 200 in FIGS. 1, 2, and 3. A representative system 300 is depicted in FIG. 4. Although the various blocks of FIG. 4 are shown with lines for the sake of clarity, in reality, delineating various components is not so clear, and metaphorically, the lines would more accurately be gray and fuzzy. The diagram of FIG. 4 is merely illustrative of an exemplary computing device or system that can be used in connection with one or more embodiments of the present subject matter. Distinction is not made between such categories as “workstation,” “server,” “laptop,” “hand-held device,” etc., as all are contemplated within the scope of FIG. 4 and reference to “processor.”

The system 300 typically includes a variety of physical computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, or any other physical medium that can be used to encode desired information and be accessed by the system 300.

The system 300 generally comprises one or more memory provisions or modules collectively shown as 310 in FIG. 4. The memory 310 stores and/or retains information and data relating to various aspects of the noted methods such as the selected labels, model(s) that predict deformation of images, least squares conformal maps (LSCM), surfaces and contours to which the label is to be applied, adapted LSCM's, and information relating to any of these aspects or their determination. The memory provisions 310 may also store and/or retain information relating to operation of the system 300, operator preferences, and other aspects and ancillary matters. Memory 310 includes computer-storage media in the form of volatile and/or nonvolatile memory. The memory may be removable, nonremovable, or a combination thereof. Exemplary hardware devices include solid-state memory, hard drives, optical-disc drives, etc.

The system 300 also comprises one or more input-output interfaces collectively shown as 320 in FIG. 4. The interfaces 320 exchange and/or accommodate user inputs, environmental inputs, and/or other operational inputs such as for example from input devices 340. Non-limiting examples of input devices 340 include operator keyboards, mouses, microphones, joysticks, satellite dishes, scanners, sensors, data ports, and/or data feeds from other systems or components. The interfaces 320 also exchange and/or provide outputs to one or more output devices or components such as shown as 350 in FIG. 4. Non-limiting examples of output devices or components 350 include displays or monitors, printers, process components, data ports, and/or data feeds to other systems or components.

The system 300 also comprises one or more processors collectively shown as 330 in FIG. 4. The processor(s) 330 process information and/or execute algorithms such as determining one or more models or representations, and determining and/or adapting least squares conformal maps (LSCM's). The processor(s) 330 are in data or information communication with the memory provisions 310 and the input-output interface 320 via one or more busses or data links 360.

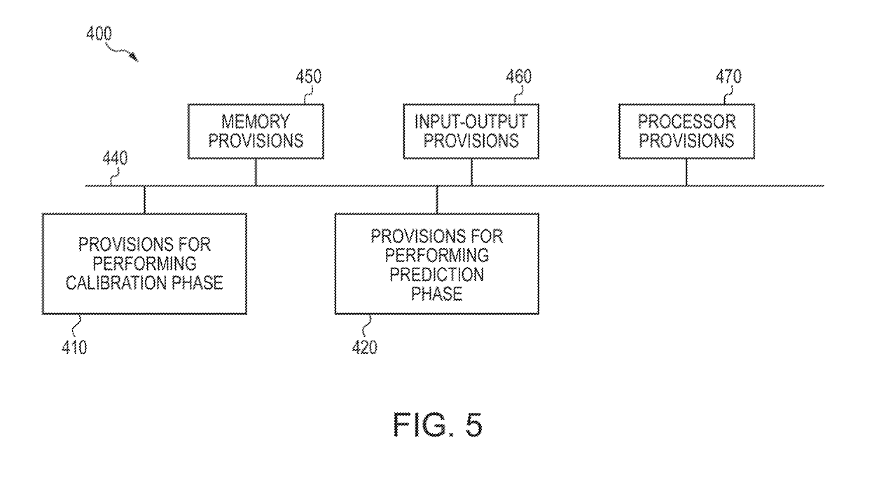

FIG. 5 is a schematic illustration of another system 400 for performing the methods of FIGS. 2 and 3. The system 400 comprises provisions for performing the previously described calibration phase collectively shown as 410, and provisions for performing the previously described prediction phase, collectively shown as 420. It will be appreciated that the provisions 410 and/or 420 can be provided in the same or different portions or partitions of the system 400 or comparable components. The provisions 410 and 420 are in communication via one or more busses 440 such as previously described bus 360 and also in communication with a processor 470 such as processor 330 depicted in FIG. 4 and/or with a memory 450 such as memory 310 in FIG. 4. The system 400 may also include input-output provisions 460 as previously described as item 320 in FIG. 4.

Thus, the present subject matter provides various computer systems and computer-readable media for performing the methods and techniques described herein. The systems can be provided in a nondistributed manner such as in a central computing device, or in a distributed architecture in which various components or provisions are separated or remote from one another. One such system which is contemplated includes a primary portion that archives or stores information or a database relating to various MDp values associated with combinations of labels and surfaces or container face contours. A business provider of label prediction services could operate or use this primary portion. The contemplated system also includes a secondary portion that serves to determine, obtain or collect information which leads to identifying an MDx value. A customer or client of the business providing the label prediction services could be granted access to the secondary portion. Either or both of the primary portion and the secondary portion performs the comparison of the MDp and MDx information and provides a prediction concerning the extent of labeling defects associated with a proposed combination of label and surface.

And, the present subject matter also provides computer-readable media for use in performing the methods described herein. It is contemplated that the computer-readable media can be in a wide array of forms including the forms and/or formats noted herein and may include other forms.

### EXAMPLES

A series of investigations were performed regarding the extent of deformation of labels varying in size and applied to identical container faces. The containers each included a curved three dimensional front surface. A series of identical labels only differing in size, were applied to identical corresponding regions, i.e. the front surface, of each container. As described below, the extent of deformation varied due to changes in the label size and region(s) of the curved surface over which the label(s) extended. This series of investigations demonstrate that even if surface geometry or contour is held constant, merely changing the size of a label can result in relatively high levels of deformation in the labels, which thereby typically lead to unacceptable levels of labeling defects.

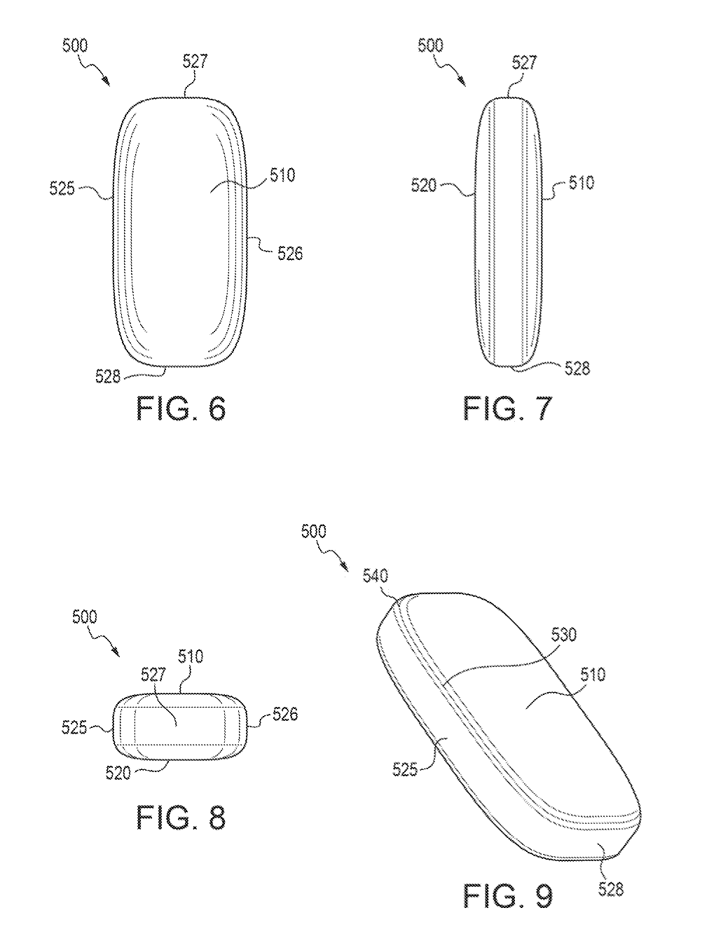

FIGS. 6-9 illustrate a representative object such as a product container 500 having a rounded front face 510, a rounded rear face 520, major sides 525 and 526, minor sides 527 and 528, rounded edges 530, and rounded corners 540. As will be appreciated, the container 500 shown is similar to many containers used in association with various personal care products such as lotions and shampoos (in such case, the container of FIGS. 6-9 is depicted without a neck or pour spout).

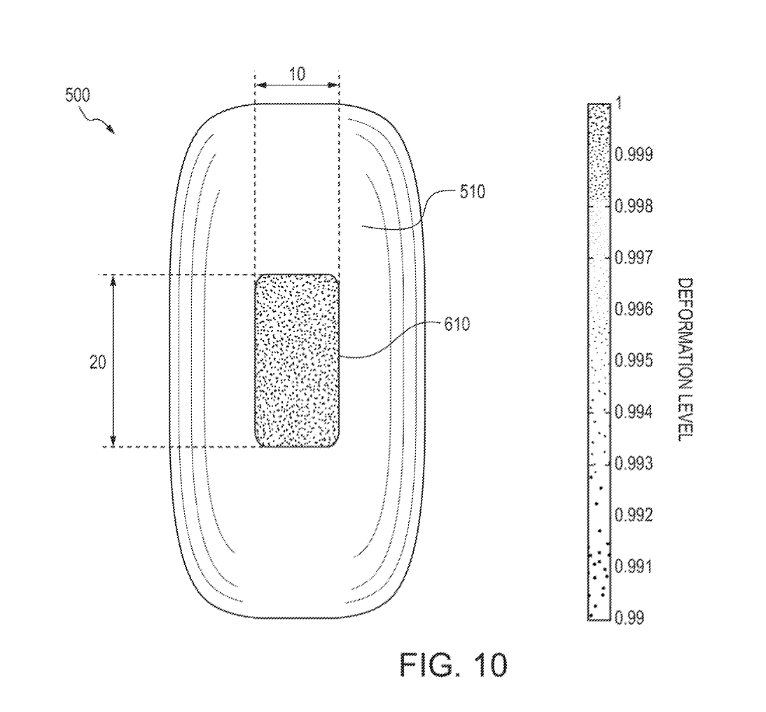

As previously noted, depending upon the size of the label and particularly the proportion of surface area of the container covered by the label, various stresses and deformations can initially exist in the label after application to the container. For example, FIG. 10 illustrates a relatively small label 610 applied to the container 500 of FIGS. 6-9. The label 610 in FIG. 10 has a surface area of 200 cm². All label dimensions noted in the figures are in cm. By referring to the accompanying scale depicting deformation level of the label, it will be appreciated that the label is not significantly deformed, and exhibits a relatively uniform and very low level of deformation across its surface area.

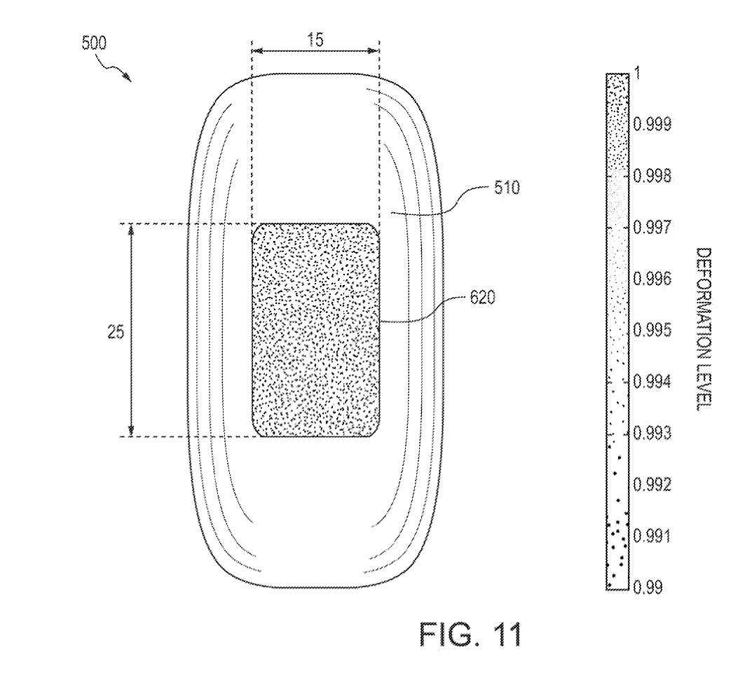

Similarly, FIG. 11 illustrates a larger sized label 620 applied to the container 500 of FIGS. 6-9. The label 620 in FIG. 11 has a surface area of 375 cm². As shown in the scale of deformation level of the label, the label is not significantly deformed, and exhibits a relatively uniform and very low level of deformation across its surface area.

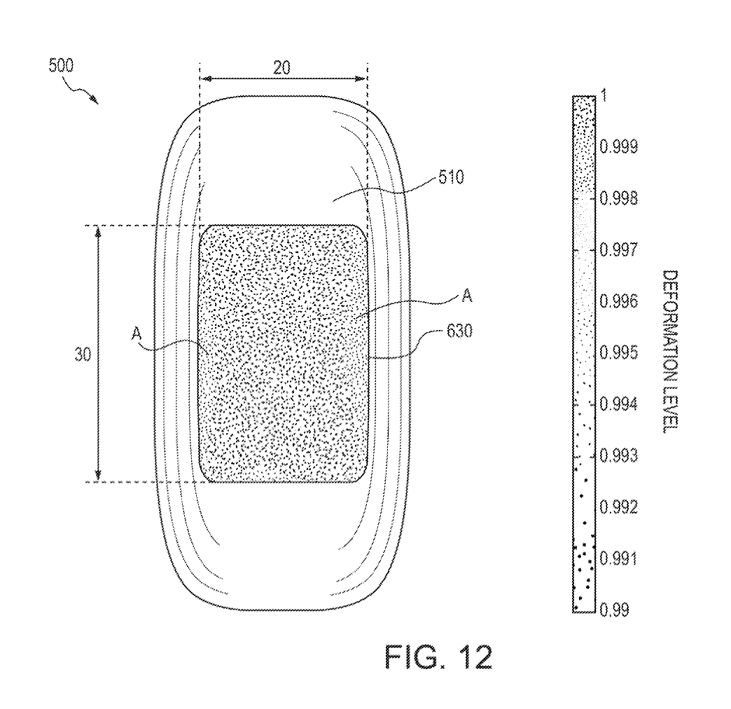

FIG. 12 illustrates another label 630, larger than the label 620 of FIG. 11, in which certain regions of the label exhibit a slight degree of deformation. The label 630 in FIG. 12 has a surface area of 600 cm². These regions of slight deformation generally extend along peripheral edge regions of the label 630, shown in FIG. 12 as edge regions A.

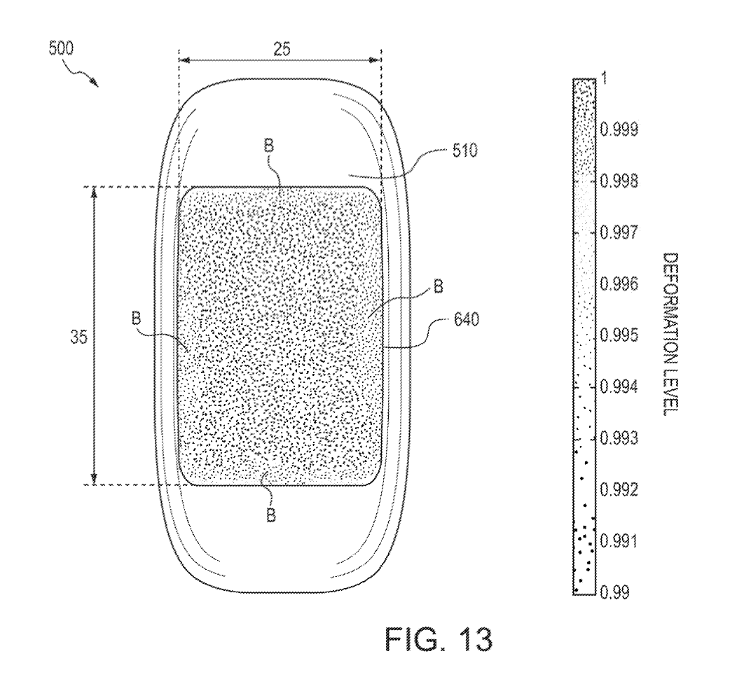

FIG. 13 illustrates another label 640, larger than the label 630 of FIG. 12, in which certain regions of the label 640 exhibit a moderate degree of deformation. The label 640 in FIG. 13 has a surface area of 875 cm². The regions of moderate deformation generally extend along peripheral edge regions of the label 640, shown in FIG. 13 as edge regions B.

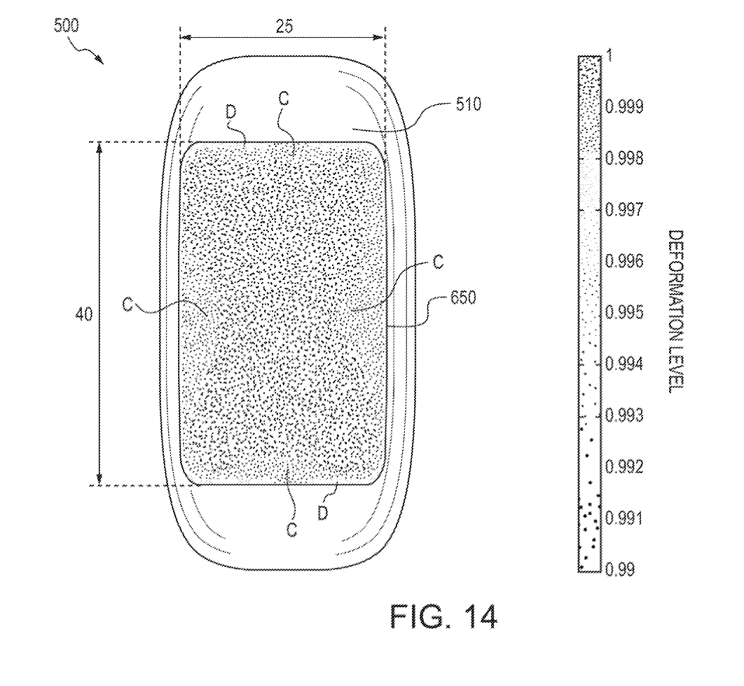

FIG. 14 illustrates another label 650, larger than the label 640 of FIG. 13, in which certain regions of the label 650 exhibit moderate degrees of deformation shown as regions C, and other regions of the label exhibit significant degrees of deformation shown as regions D. The label 650 in FIG. 14 has a surface area of 1,000 cm². Both of the regions, i.e. regions of moderate and significant deformation, extend along the edges of the label with the regions of significant deformation D generally extending immediately adjacent to the edge(s) of the label.

Although the present subject matter and its various preferred embodiments have been described in terms of applying labels, and particularly pressure sensitive shrink labels, onto curved surfaces of containers, it will be understood that the present subject matter is applicable to applying labels, films, or other thin flexible members upon other surfaces besides those associated with containers. Moreover, it is also contemplated that the subject matter can be used to apply such components onto developable (relatively flat planar) surfaces.

Additional details associated with applying pressure sensitive labels, and particularly pressure sensitive shrink labels, are provided in International Publication WO 2008/124581; US Patent Application Publication 2009/0038736; and US Patent Application Publication 2009/0038737. Additional details associated with heat transfer labeling technology are provided in U.S. Pat. No. 4,610,744; U.S. Pat. No. 6,698,958; US Patent Application Publication 2008/0185093; US Patent Application Publication 2007/0275319; US Patent Application Publication 2007/0009732; US Patent Application Publication 2005/0100689; International Publication WO 2004/050262; International Publication WO 2005/069256; U.S. Pat. No. 7,758,938; U.S. Pat. No. 6,756,095; International Publication WO 2002/055295; U.S. Pat. No. 6,228,486; U.S. Pat. No. 6,461,722; International Publication WO 2000/20199; International Publication WO 2000/23330; U.S. Pat. No. 6,796,352; International Publication WO 2002/12071; US Patent Publication 2007/0281137; and International Publication WO 2007/142970.

Many other benefits will no doubt become apparent from future application and development of this technology.

All patents, applications, and articles noted herein are hereby incorporated by reference in their entirety.

As described hereinabove, the present subject matter solves many problems associated with previous strategies, systems or devices. However, it will be appreciated that various changes in the details, materials and arrangements of components and operations, which have been herein described and illustrated in order to explain the nature of the subject matter, may be made by those skilled in the art without departing from the principle and scope of the subject matter, as expressed in the appended claims.

What is claimed is:

1. A method for identifying a maximum label deformation resulting from applying a label to a three dimensional surface, the method comprising:
providing a representation of a three dimensional surface which is to receive a label;
performing a mapping method upon the three dimensional surface which is to receive a label, utilizing the representation;
whereby the mapping method provides a two dimensional map of the three dimensional surface and identifies a maximum deformation of a label applied to the surface.

2. The method of claim 1 wherein the representation of the three dimensional surface is a mathematical model.

3. The method of claim 1 wherein the representation of the three dimensional surface is a virtual representation.

4. The method of claim 1 wherein the mapping method is a Least Squares Conformal Mapping method.

5. The method of claim 1 wherein the three dimensional surface is an external surface of a container.

6. The method of claim 1 wherein the three dimensional surface includes a region defined by a non-developable surface.

7. A method for identifying a maximum deformation of a label applied to a surface of interest, in which the labeled surface after label application will also exhibit an acceptable level of labeling defects, the method comprising:
providing a collection of physical models each having a surface of interest, the models having progressively increasing Gaussian curvature within the surface of interest;
providing a plurality of labels;
applying a label from the plurality of labels to each corresponding model and within the surface of interest to thereby produce a collection of labeled models;
defining an acceptable level of labeling defects for the label and the surface of interest;
inspecting the collection of labeled models whereby a single labeled model having the greatest Gaussian curvature yet which exhibits an acceptable level of labeling defects is identified;
applying a mapping method to the surface of interest of at least the labeled model having the greatest Gaussian curvature yet which exhibits an acceptable level of labeling defects, to thereby identify the maximum deformation of the label applied to the surface of interest.

8. The method of claim 7 wherein the applying the mapping method is applied to the surface of interest of each of the labeled models.

9. The method of claim 7 wherein the mapping method is a Least Squares Conformal Mapping method.

10. The method of claim 7 wherein the surface of interest is a three dimensional surface and includes at least one region defined by a non-developable surface.

11. The method of claim 7 wherein the maximum deformation of the label applied to the surface of the model exhibiting an acceptable level of labeling defects is MDp, the method further comprising:
providing a proposed second surface of interest;
applying a mapping method to the proposed second surface of interest, to thereby identify a maximum deformation associated with the proposed second surface MDx;
comparing MDp and MDx, whereby if MDx is less than or equal to MDp, then the proposed second surface of interest is deemed to be acceptable for receiving a label.

12. The method of claim 11 wherein the mapping method applied to the proposed second surface of interest is a Least Squares Conformal Mapping method.

13. The method of claim 11 wherein if MDx is greater than MDp, then the proposed second surface of interest is deemed to be unacceptable.

14. A system for identifying a maximum label deformation associated with applying a label to a three dimensional surface, the system comprising:
means for performing a mapping method upon a three dimensional surface which is to receive a label and identify a maximum deformation of the label.

15. The system of claim 14 further comprising:
means for providing a representation of the three dimensional surface which is to receive a label.

16. The system of claim 14 further comprising:
output provisions for indicating the maximum deformation of the label to an operator.

17. The system of claim 14 further comprising:
input provisions for communicating information to the means for performing the mapping method.

18. The system of claim 14 further comprising:
input provisions for communicating information to the means for providing the representation.

19. A system for identifying a maximum deformation of a label applied to a proposed curved surface of interest, which after label application will also exhibit an acceptable level of labeling defects, the system comprising:
means for performing a mapping method upon a representation of a reference surface of interest which exhibits the greatest Gaussian curvature yet which also exhibits an acceptable level of labeling defects upon application of a label thereto, wherein the means for performing the mapping method identifies the maximum deformation of the label applied to the reference surface of interest, MDp;
means for performing a mapping method upon a representation of a proposed surface of interest and identifying the maximum deformation associated with the proposed surface, MDx;
means for comparing the maximum deformation of the label applied to the reference surface of interest MDp with the maximum deformation associated with the proposed surface MDx.

20. The system of claim 19 further comprising:
means for providing the representation of the reference surface of interest.

21. The system of claim 19 further comprising:
means for providing the representation of the proposed surface of interest.

22. The system of claim 19 further comprising:
output provisions for providing information to an operator.

23. The system of claim 19 further comprising:
input provisions for communicating information to at least one of (i) the means for performing the mapping method upon the representation of the reference surface of interest, and (ii) the means for performing the mapping method upon the representation of the proposed surface of interest.

24. One or more computer-readable media having computer-usable instructions embodied thereon to perform a method for identifying a maximum label deformation resulting from applying a label to a three dimensional surface, the method comprising:
providing a representation of a three dimensional surface which is to receive a label;
performing a mapping method upon the three dimensional surface which is to receive a label, utilizing the representation;
whereby the mapping method provides a two dimensional map of the three dimensional surface and identifies a maximum deformation of a label applied to the surface.

25. One or more computer-readable media having computer-usable instructions embodied thereon to perform a method for identifying maximum deformation of a label applied to a surface of interest, in which the labeled surface after label application will also exhibit an acceptable level of labeling defects, the method comprising:
providing a collection of physical models each having a surface of interest, the models having progressively increasing Gaussian curvature within the surface of interest;
providing a plurality of labels;
applying a label from the plurality of labels to each corresponding model and within the surface of interest to thereby produce a collection of labeled models;
defining an acceptable level of labeling defects for the label and the surface of interest;
inspecting the collection of labeled models whereby a single labeled model having the greatest Gaussian curvature yet which exhibits an acceptable level of labeling defects is identified;
applying a mapping method to the surface of interest of at least the labeled model having the greatest Gaussian curvature yet which exhibits an acceptable level of labeling defects, to thereby identify the maximum deformation of the label applied to the surface of interest.

26. The one or more computer-readable media of claim 25 wherein the maximum deformation of the label applied to the surface of the model exhibiting an acceptable level of labeling defects is MDp, the method further comprises:
providing a proposed second surface of interest;
applying a mapping method to the proposed second surface of interest, to thereby identify a maximum deformation associated with the proposed second surface MDx;
comparing MDp and MDx, whereby if MDx is less than or equal to MDp, then the proposed second surface of interest is deemed to be acceptable for receiving a label.
